(19) United States
(12) Patent Application Publication
(10) Pub. No.: US 2026/0285215 A1
(43) Pub. Date: Sep. 24, 2026

(54) LAUNCHING SYSTEM FOR TOWING AND LAUNCHING WATERCRAFT

(71) Applicant: Lone Launcher, LLC, Clearwater, FL (US)

(72) Inventor: Jesse Lee Dawson, Clearwater, FL (US)

(21) Appl. No.: 19/690,751

(22) Filed: May 28, 2026

Related U.S. Application Data
(63) Continuation of application No. PCT/US25/41114, filed on Aug. 7, 2025.
(60) Provisional application No. 63/694,965, filed on Sep. 16, 2024.

(51) Int. Cl. B60P 3/10; B60P 1/24; B60P 1/28

(52) U.S. Cl. CPC B60P 3/1066; B60P 1/24; B60P 1/283; B60P 3/1075

(57) ABSTRACT

Disclosed herein is a launching system for towing and launching a watercraft including a frame including a vehicle side and a water side, a first lift rail coupled to the vehicle side of the first bracket set, a second lift rail coupled to the vehicle side of the first bracket set, a first ramp rail coupled to the water side of the second bracket set, a second ramp rail coupled to the water side of the second bracket set, and a lift actuator located toward the vehicle side of the frame, configured to change a position of the first lift rail and the second lift rail with regard to the frame, thus changing a lift angle such that the watercraft slides from the first lift rail and the second lift rail to the first ramp rail and the second ramp rail during launch.

### CROSS REFERENCE TO RELATED APPLICATION

This application is a continuation-in-part of P.C.T. Application Number PCT/US2025/041114, filed on August 7, 2025, which claims the benefit of Provisional Application Serial Number 63/694,965, filed on September 16, 2024, both of which are hereby incorporated by reference in their entireties.

### TECHNICAL FIELD

The present specification generally relates to boat and personal watercraft trailers used for retrieving, transporting and launching boats and, more specifically, a boat or personal watercraft trailer having height adjustable rollers or bunk boards for launching and loading a boat into a body of water without the use of a boat ramp.

### BACKGROUND

Currently in the United States there are over 800,000 lakes of one hectare or more and only 28,000 boat ramps. Furthermore, in-water storage of watercraft is limited to property owners who have parcels of land adjacent to bodies of water, such as lakes. As such, most watercraft owners, or users, are required to transport their watercraft to a body of water and launch into the body of water. Traditionally, transporting the watercraft requires a trailer specifically adapted for towing the watercraft and a vehicle to tow the trailer. Also, launching a watercraft requires a ramp for entering the body of water.

Launching a watercraft utilizing one of the approximately 28,000 boat ramps available requires a user to back their vehicle into the body of water such that the watercraft floats off the trailer. This process is disadvantageous because it limits watercraft access to areas where boat ramps are located, can cause a loss of the vehicle if the vehicle slides into the body of water and becomes submerged, and traditionally requires at least one additional user to pilot the boat while the first user operates the vehicle.

Additional difficulties arise when hauling and launching a personal watercraft, such as a water scooter, single user recreational watercraft, JetSkiI™, WaveRunner™, etc. These personal watercraft often have an elevated, sloping front surface that can slip or move on traditional launching systems. Accordingly, an ongoing need exists for enhanced systems to safely deploy personal watercraft and other single or multi person watercraft in the direction of desired travel.

Accordingly, a need exists for an improved launching system for towing and launching a watercraft having an integrated ramp system thereby allowing a single user to launch a boat without the need for a dedicated boat ramp. Additionally, a need exists for an improved systems that allows a single user to launch a watercraft with complex geometry oriented to face the water.

In one embodiment, a launching system for towing and launching a watercraft is provided. Some embodiments include a frame including a vehicle side and a water side, where the frame includes at first lift rail bracket and a second lift rail bracket, and a first ramp rail bracket and a second ramp rail bracket, a first lift rail coupled to the vehicle side of the first lift rail bracket such that the first lift rail rotates about the first lift rail bracket. The first lift rail may be disposed along a launch direction and a second lift rail may be coupled to the vehicle side of the first lift rail bracket such that the second lift rail rotates about the second lift rail bracket. The second lift rail may be disposed along the launch direction, where the first lift rail and the second lift rail rotate about the first lift rail bracket and second lift rail bracket to create a lift angle with respect to the frame, and where the watercraft is disposed on the first lift rail and the second lift rail during towing. Some embodiments include a first ramp rail coupled to the water side of the first ramp rail bracket such that the first ramp rail rotates about the first ramp rail bracket, where the first ramp rail is positioned in between the first lift rail and the frame and is disposed along the launch direction during launch, and where the first ramp rail extends past the first ramp rail bracket so that a portion of the first ramp rail is parallel to and collinear with the first lift rail. Some embodiments include a second ramp rail coupled to the water side of the second ramp rail bracket such that the second ramp rail rotates about the second ramp rail bracket, where the second ramp rail substantially aligns with the second lift rail and is disposed along the launch direction during launch, where the first ramp rail and the second ramp rail rotate about the first ramp rail bracket and the second ramp rail bracket to create a ramp angle with respect to the frame. Some embodiments include a lift actuator located toward the vehicle side of the frame configured to change a position of the first lift rail and the second lift rail with regard to the frame, thus changing the lift angle such that the watercraft slides from the first lift rail and the second lift rail to the first ramp rail and the second ramp rail during launch, where when the watercraft is disposed on the first ramp rail and the second ramp rail during launch, a weight of the watercraft causes the ramp angle to increase to be greater than the lift angle as the watercraft enters a body of water.

Another embodiment includes a launching system for towing and launching a watercraft. The launching system may include a frame including a vehicle side and a water side, a first support rail that extends in a substantially perpendicular direction the frame, and a second support rail extends substantially parallel to the first support rail on the water side of the frame. The first support rail and the second support rail may define an intermediate section, where the second support rail includes a first lift rail bracket and second lift rail bracket, and a first ramp rail bracket and a second ramp rail bracket and wherein the first ramp rail bracket is disposed between the first lift rail bracket and the frame. The second ramp rail bracket may be disposed between the second lift rail bracket and the frame. Some embodiments may include a first lift rail coupled to the vehicle side of the first lift rail bracket such that the first lift rail rotates about the first lift rail bracket, where the first lift rail is disposed along a launch direction and a second lift rail coupled to the vehicle side of the second lift rail bracket such that the second lift rail rotates about the second lift rail bracket. The second lift rail may be disposed along the launch direction, where the first lift rail and the second lift rail rotate about the first lift rail bracket and the second lift rail bracket to create a lift angle with respect to the frame, and where the watercraft is disposed on the first lift rail and the second lift rail during towing. Some embodiments include a first ramp rail coupled to the water side of the first ramp rail bracket such that the first ramp rail rotates about the first ramp rail bracket, where the first ramp rail substantially aligns with the first lift rail and is disposed along the launch direction during launch. Some embodiments include a second ramp rail coupled to the water side of the second ramp rail bracket such that the second ramp rail rotates about the second ramp rail bracket, where the second ramp rail substantially aligns with the second lift rail and is disposed along the launch direction during launch. The first ramp rail and the second ramp rail may be configured to rotate about the first ramp rail bracket and the second ramp rail bracket to create a ramp angle with respect to the frame. Some embodiments include a lift actuator located toward the vehicle side of the frame, configured to change a position of the first lift rail and the second lift rail with regard to the frame, thus changing the lift angle such that the watercraft slides from the first lift rail and the second lift rail to the first ramp rail and the second ramp rail during launch. Some embodiments include a flotation device that is secured toward the water side of the first ramp rail and the second ramp rail during launch and between the first ramp rail and the second ramp rail during launch. In some embodiments, when the watercraft is disposed on the first ramp rail and the second ramp rail during launch, a weight of the watercraft causes the ramp angle to increase to be greater than the lift angle as the watercraft enters a body of water.

In yet another embodiment, a launching system for towing and launching a watercraft includes a frame including a vehicle side and a water side, where the frame includes at least one lift rail bracket and at least one ramp rail bracket and at least one lift rail coupled to the vehicle side of the at least one lift rail bracket such that the at least one lift rail rotates about the at least one lift rail bracket, where the at least one lift rail is disposed along a launch direction. The at least one lift rail may be configured to rotate about the at least one lift rail bracket to create a lift angle with respect to the frame, where the watercraft is disposed on the at least one lift rail during towing. In some embodiments, the system may include at least one ramp rail coupled to the water side of the at least one ramp rail bracket such that the at least one ramp rail rotates about the at least one ramp rail bracket, where the at least one ramp rail substantially aligns with the at least one lift rail and is disposed along the launch direction during launch. The at least one ramp rail may be configured to rotate about the at least one ramp rail bracket to create a ramp angle with respect to the frame. The system may include a first actuator located toward the vehicle side of the frame, configured to change a position of the at least one lift rail with regard to the frame, thus changing the lift angle such that the watercraft slides from the at least one lift rail to the at least one ramp rail during launch and a second actuator that is secured toward the vehicle side of the frame, configured to control speed of the watercraft during launch and assist loading of the watercraft before towing.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A schematically depicts an embodiment of a launching system for towing and launching a watercraft, according to one or more embodiments shown and described herein;

FIG. 1B is an enlarged view of a portion of the launching system, according to one or more embodiments shown and described herein;

FIG. 1C is an enlarged view of a portion of the launching system, according to one or more embodiments shown and described herein;

FIG. 2 is a view of an embodiment of a launching system for towing and launching a watercraft, shown in use, according to one or more embodiments shown and described herein;

FIG. 3 is a view of an embodiment of a launching system for towing and launching a watercraft, shown extended, according to one or more embodiments shown and described herein;

FIG. 4A is a top plan view of an embodiment of a launching system for towing and launching a watercraft, shown extended, according to one or more embodiments shown and described herein;

FIG. 4B is an enlarged view of a portion of the launching system, according to one or more embodiments shown and described herein;

FIG. 4C is an enlarged view of a portion of the launching system, according to one or more embodiments shown and described herein;

FIG. 4D is an enlarged view of a portion of the launching system, according to one or more embodiments shown and described herein;

FIG. 5A is a top plan view of an embodiment of a launching system for towing and launching a watercraft, shown stored, according to one or more embodiments shown and described herein;

FIG. 5B is an enlarged view of a portion of the launching system, according to one or more embodiments shown and described herein;

FIG. 5C is an enlarged view of a portion of the launching system, according to one or more embodiments shown and described herein; and

FIG. 6 is a rear elevation view of an embodiment of a launching system for towing and launching a watercraft, according to one or more embodiments shown and described herein.

FIGS. 7A, 7B provide a plurality of views of a launching system for towing and launching a single person watercraft, according to one or more embodiments shown and described herein;

FIGS. 8A-8C provide various side views of a launching system for towing and launching a personal watercraft, according to one or more embodiments shown and described herein; and

FIGS. 9A, 9B provide various side views of a launching system for towing and launching a personal watercraft, according to one or more embodiments shown and described herein.

### DETAILED DESCRIPTION

Embodiments described herein are directed to a launching system for towing, launching, and recovering a watercraft, which includes features configured to facilitate movement of a watercraft between a hauling position and a launching position relative to a body of water. The launching system includes a frame, at least one lift rail, at least one ramp rail, a winch actuator, a winch cable, a flotation device, bunk boards, and various attachment and support mechanisms configured to allow the watercraft to be transported by a vehicle and transferred to and from the water. The purpose of the launching system is to provide a process for launching and recovering a watercraft, minimizing manual effort and reducing the potential for damage to the watercraft. Some embodiments include a system and/or process for launching and recovering a personal watercraft in the direction of desired travel.

Various embodiments of the apparatus and its operation are described in more detail herein. Whenever possible, the same reference numerals will be used throughout the drawings to refer to the same or like parts, directional terms as used herein (for example up, down, right, left, front, back, top, bottom) are made only with reference to the figures as drawn and are not intended to imply absolute orientation.

As used herein, the singular forms “a,” “an” and “the” include plural referents unless the context clearly dictates otherwise. Thus, for example, reference to “a” component includes aspects having two or more such components, unless the context clearly indicates otherwise.

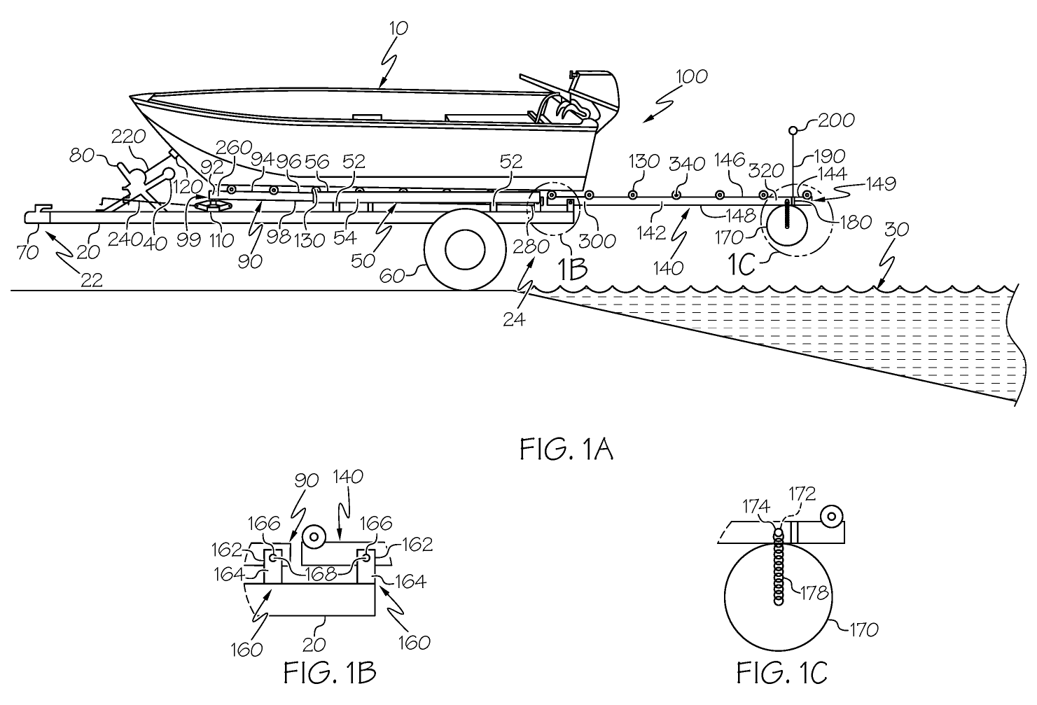

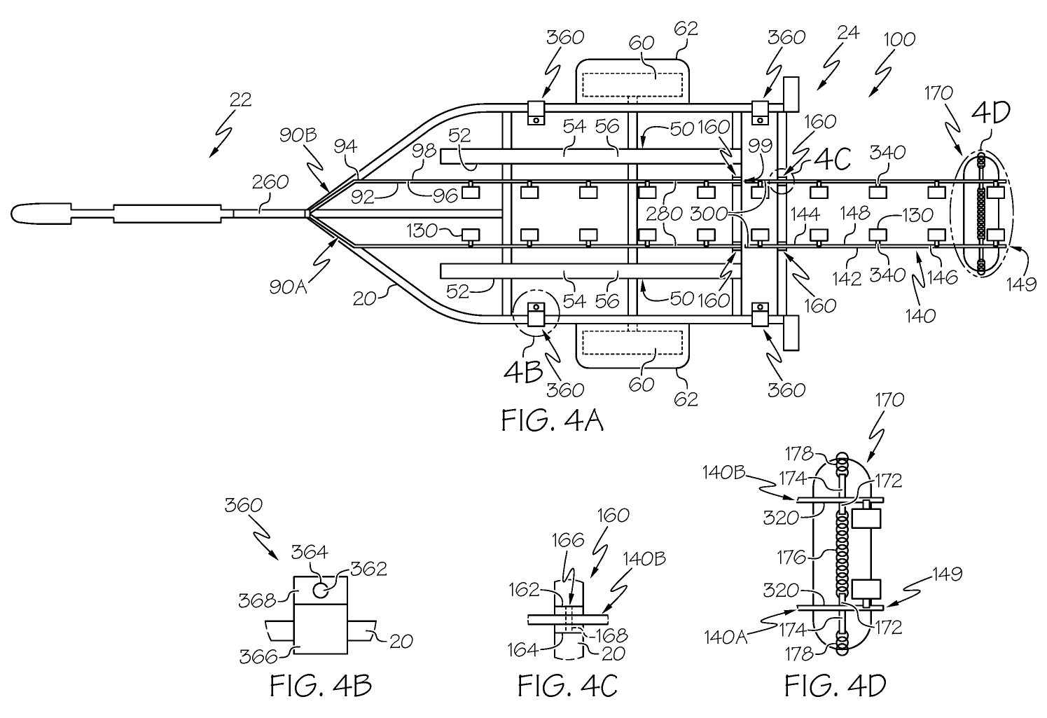

Referring now to FIGS. 1A-1C, a launching system 100 is illustrated according to one or more embodiments described herein. The launching system 100 may be used for towing and launching a watercraft 10. FIG. 1A depicts one possible configuration of the launching system 100. The launching system 100 includes a frame 20, which is arranged with a vehicle side 22 and a water side 24. The frame 20 is a structure that may support a watercraft 10, such as a boat or a JetSkiI™, and is configured to connect to a hauling vehicle, for example, a truck, by way of a tow hitch assembly 70. The frame 20 is a rigid structure that may be made of metals or other strong materials to provide support and durability. The frame 20 includes wheels 60 and as such may be pulled by a vehicle when attached via the tow hitch assembly 70. The wheels 60 may include a fender 62 (see FIG. 4) to protect the wheels 60 from debris and environmental exposure. The frame 20 may further include a second actuator 80, which in embodiments may be a winch actuator, lead screw actuator, cable-based actuator, belt-based actuator, a telescoping actuator, a column-style actuator, a scissor, lift actuator cable-driven actuator, a belt-drive linear actuator, a chain-driven actuator, a strap actuator, a webbing actuator, a rack-and-pinion actuator, a lead screw actuator, a ball screw actuator, a pully-amplified linear actuator, a tension-based actuator, a rotary actuator, etc., which is securely fastened to the frame 20 and is configured to rotate. The second actuator 80 is adapted to pull a winch cable 220 and whatever is coupled to the winch cable 220, such as the watercraft 10. The second actuator 80 may also include a bow stop 40, which is configured to ultimately stop any watercraft 10 from being pulled too far up the frame 20 or too close to the vehicle. The watercraft 10 may include a bow eye 120 securely attached to the watercraft 10 and configured to couple to the winch cable 220 and be pulled by the second actuator 80, thereby pulling the watercraft 10.

The launching system 100 may be movable between a hauling position and a launching position. The frame 20 may also include at least one bunk board 50 for use in the hauling position. When the launching system 100 is in the hauling position, the watercraft 10 is resting upon the at least one bunk board 50. The at least one bunk board 50 includes a support 52, a pad 54, and a top surface 56 of the pad 54. The support 52 is the part of the at least one bunk board 50 that is rigidly attached to the frame 20 and is covered by the pad 54. The pad 54 is made of a softer material, such as rubber, and the top surface 56 may be covered by an even more protective material, such as marine carpet, as this surface may contact the watercraft 10 and prevents scratching or other damage.

The main components of the launching system 100 that are attached to the frame 20 and that need to adjust positions when the launching system 100 is moving between the hauling position and the launching position are a lift rail 90 and a ramp rail 140. The lift rail 90 is a rail that adjusts position to engage with the watercraft 10 and provide a channel for the watercraft 10 to move to the ramp rail 140 when the watercraft 10 is being launched into the water 30. This operation may be reversed when the watercraft 10 is being recovered from the water 30. The lift rail 90 adjusts its position on an angle. The lift rail 90 includes a first side surface 92, a second side surface 94 opposite the first side surface 92, a top surface 96, a bottom surface 98 opposite the top surface 96, and an aperture 99 (one or more) that is parallel to the first side surface 92, second side surface 94, top surface 96, and bottom surface 98. The lift rail 90 further includes a front engaging portion 260 located closer to the vehicle side 22 of the frame 20 and a rear engaging portion 280, which is located opposite the front engaging portion 260 and is closer to the water side 24 of the frame 20. In the embodiment depicted in FIG. 1A, the lift rail 90 starts as a single rail in the front engaging portion 260 and splits into two lift rails 90A, 90B in the rear engaging portion 280. Other embodiments may include a single rail extending from the front engaging portion 260 to the rear engaging portion 280, or with two rails, connected at any point, extending from the front engaging portion 260 to the rear engaging portion 280.

The lift rail 90 includes at least one roller 130, which itself includes a roller axis 340 attached to the top surface 96 of the lift rail 90 that allows the roller 130 to rotate freely. The roller axis 340 is rigidly attached to the top surface 96 of the lift rail 90. In some embodiments, the roller axis 340 may be extended over the first side surface 92 or the second side surface 94. The roller 130 may be made of rubber or another soft material that allows the watercraft 10 to move along multiple rollers 130 without damage. The front engaging portion 260 of the lift rail 90 is attached to a first actuator 110, which in embodiments may be a lift actuator, lead screw actuator, cable-based actuator, belt-based actuator, a rack-and-pinion actuator, a telescoping actuator, a column-style actuator, a scissor, lift actuator, cable-driven actuator, a belt-drive linear actuator, a chain-driven actuator, a strap actuator, a webbing actuator, a lead screw actuator, a ball screw actuator, a pully-amplified linear actuator, a tension-based actuator, a rotary actuator, etc. a fluid-powered actuator, that is rigidly connected to the frame 20. The first actuator 110 may be mechanically operated by a lift crank 240 and is configured to lift the front engaging portion 260 of the lift rail 90. The lift crank 240 may move portions of the first actuator 110 so that the space between the top and the bottom of the first actuator 110 increases or decreases. The first actuator 110 may also be electronically operated without the use of the lift crank 240. When the first actuator 110 is fully retracted, the rollers 130 on the lift rail 90 are not adjacent the watercraft 10. As depicted in FIG. 1A, the first actuator 110 is extended enough that the rollers 130 on the lift rail 90 are adjacent the bottom of the watercraft 10, such that the watercraft 10 is no longer adjacent the pad 54 of the at least one bunk board 50.

The ramp rail 140 is a rail that may adjust position to engage with the watercraft 10 and may allow the watercraft 10 to move into the water 30 during launching. This may also be reversed when the watercraft 10 is being recovered from the water 30. As such, the ramp rail 140 may allow the watercraft 10 to move onto the rollers 130 of the lift rail 90 during recovering. The ramp rail 140 may be in a first location when the launching system 100 is in a hauling position and may completely disengage from the frame 20 and reengage with the frame 20 at a second location when the launching system 100 is in the launching position. The ramp rail 140 includes a first side surface 142, a second side surface 144 opposite the first side surface 142, a top surface 146, a bottom surface 148 opposite the top surface 146, and an aperture 149 that is parallel to the first side surface 142, the second side surface 144, the top surface 146, and the bottom surface 148. The ramp rail 140 includes a front engaging portion 300 closer to the water side 24 of the frame 20 in both the first and second locations, and a rear engaging portion 320, which is opposite the front engaging portion 300 and is further from the water side 24 of the frame 20 in both the first and second locations. At least one ramp rail 140 may assist in moving the watercraft 10. In the embodiment depicted in FIG. 1A, two ramp rails 140 are included.

The ramp rail 140 includes at least one roller 130, which includes a roller axis 340 attached to the top surface 146 of the ramp rail 140 that allows the roller 130 to rotate freely. The roller axis 340 is rigidly attached to the top surface 146 of the ramp rail 140 and connected to the roller axis 340 of the roller 130. In some embodiments, the roller axis 340 may be extended over the first side surface 142 or the second side surface 144. The roller 130 may be made of rubber or another soft material that allows the watercraft 10 to move along multiple rollers 130 without damage. The ramp rail 140 may be installed in the second position with at least one roller 130 already adjacent the bottom of the watercraft 10.

The launching system 100 may include more than one ramp rail 140. Multiple rollers 130 of the multiple ramp rails 140 may be considered a first plurality of rollers 130 engaged to a first plurality of roller axes 340. The launching system 100 may also include more than one lift rail 90. Multiple rollers 130 of the multiple lift rails 90 may be considered a second plurality of rollers 130 engaged to second plurality of roller axes 340, which may include first roller axes and second roller axes.

The rear engaging portion 320 of the ramp rail 140 is rigidly attached to a spring base 180 that is connected to a pole 190, which in turn is connected to a ring 200. The ring 200 is configured to allow secure holding of the winch cable 220. The flexibility of the spring base 180 and the pole 190 is configured to allow the watercraft 10 to move them, and therefore move the ring 200, but to remain generally perpendicular to the ramp rail 140 when not being touched by the watercraft 10. When the spring base 180 and pole 190 are oriented perpendicular to the ramp rail 140, the ring 200 is significantly out of the water 30 and able to be grabbed by a user of the watercraft 10 when the watercraft 10 is in the water 30. When the watercraft 10 is in the water 30, the user may therefore easily move the winch cable 220 between the bow eye 120 and the ring 200 as needed after launching the watercraft 10 into the water 30 or before recovering the watercraft 10 from the water 30.

FIG. 1B closely depicts a bracket 160. The frame 20 includes brackets 160 that are rigidly attached to the frame 20 and are configured to attach the lift rails 90 and ramp rails 140 of the launching system 100, allowing them to rotate about the brackets 160. The bracket 160 includes an inner support 162, an outer support 164, and an aperture 166. The inner support 162 and the outer support 164 are located on opposing sides of the lift rail 90 or ramp rail 140 when the lift rail 90 or ramp rail 140 is attached to the bracket 160. The aperture 166 of the bracket 160 passes through both the inner support 162 and the outer support 164. The bracket 160 further includes a pin 168 that fits through the aperture 166 in the inner support 162 and the aperture 166 in the outer support 164. The lift rail 90 and the ramp rail 140 may also include apertures that may align with the aperture 166 and fit around the pin 168, allowing the lift rail 90 and the ramp rail 140 to rotate about the bracket 160. The ability of the lift rail 90 to rotate about the bracket 160 allows the rising of the front engaging portion 260 of the lift rail 90 by the first actuator 110. The ability of the ramp rail 140 to rotate about the bracket 160 allows the ramp rail 140 to contact the bottom of the watercraft 10 in the second position when the watercraft 10 is mostly above the lift rail 90 and allow the watercraft 10 to be launched into the water 30 when the watercraft 10 is mostly above the ramp rails 140.

FIG. 1C depicts a flotation device 170 and shows how the flotation device 170 connects to the ramp rail 140. The embodiment of the flotation device 170 in FIGS. 1A and 1C is generally cylindrical with rounded ends. The flotation device 170 is configured to contact the water 30 while keeping the ramp rail 140 stable in comparison to the flotation device 170 or other ramp rails 140. The flotation device 170 includes at least one inner protrusion 172, at least one outer protrusion 174, an inner chain 176 (see FIG. 4D) and at least one outer chain 178. The inner protrusion 172 of the flotation device 170 depicted in FIGS. 1A and 1C is rigidly attached to the second side surface 144 of the ramp rail 140, extends away from the first side surface 142 of the ramp rail 140, and may be connected to another inner protrusion 172 by the inner chain 176 (see FIG. 4D). The outer protrusion 174 of the flotation device 170 depicted in FIGS. 1A and 1C is rigidly attached to the first side surface 142 of the ramp rail 140, extends away from the second side surface 144 of the ramp rail 140, and may be connected to the center of the rounded end of the flotation device 170 by the outer chain 178.

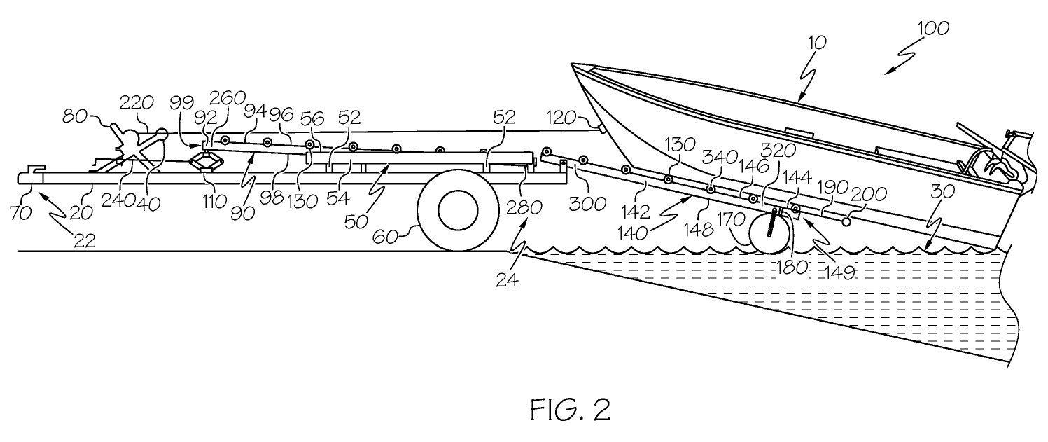

FIG. 2 illustrates the embodiment of the launching system 100 that is shown in FIG. 1A. In FIG. 2, the first actuator 110, which is attached to the frame 20 and coupled to the front engaging portion 260 of the lift rails 90, is extended further than as depicted in FIG. 1A, allowing the watercraft 10 to roll along the rollers 130 of the lift rails 90. The first actuator 110 may be configured to extend even further to launch the watercraft 10 into the water 30 or may be extended less and still allow for the watercraft 10 to be launched, depending on the specific requirements of the launch. The watercraft 10 may be configured to roll only so long as the winch cable 220 of the second actuator 80, still attached to the bow eye 120 of the watercraft 10, is allowed to extend away from the second actuator 80. As depicted in FIG. 2, the watercraft 10 has rolled completely off the lift rails 90 and is now positioned on the rollers 130 of the ramp rails 140, while still attached to the winch cable 220 at the bow eye 120. When the watercraft 10 is supported on the ramp rails 140, the ramp rails 140 assume a more drastic angle, as their only connection to the frame 20 is at the brackets 160, and the flotation device 170 is positioned adjacent the water 30. The watercraft 10 may physically override the pole 190 and the ring 200 along its path, and because of the flexibility of the spring base 180 and the pole 190, the watercraft 10 does not disconnect these components during movement. The winch cable 220 may continue to extend away from the second actuator 80, as seen in FIG. 2, when the watercraft 10 is adjacent the water 30.

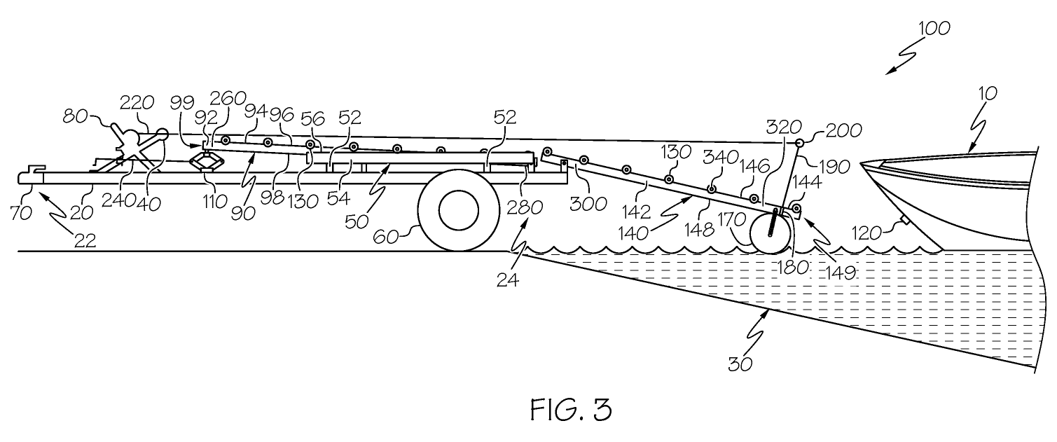

FIG. 3 illustrates the embodiment of the launching system 100 shown in FIGS. 1A and 2. In FIG. 3, the watercraft 10 is depicted as fully launched into the water 30. Due to the flexibility of the spring base 180 and the pole 190, the pole 190 is depicted as extending straight back up, generally perpendicular to the ramp rail 140, and connected to the ring 200, near the top edge of the watercraft 10, making the ring 200 easily accessible by a user of the watercraft 10. When the watercraft 10 is fully launched into the water 30, the user may disconnect the winch cable 220 from the bow eye 120 of the watercraft 10 and connect it to the ring 200. The winch cable 220 being easily accessible at the ring 200 allows the user of the watercraft 10 to approach the launching system 100 after using the bow eye 120 and to easily grasp the winch cable 220 to disconnect it from the ring 200 and reconnect it to the bow eye 120. The connection of the winch cable 220 to the bow eye 120 may also allow the watercraft 10 to be recovered onto the launching system 100 by operation of the second actuator 80 pulling the winch cable 220 while it is connected to the bow eye 120.

Referring now to FIGS. 4A-4D, FIG. 4A shows an embodiment of the launching system 100 in a launching position and from a top view. This embodiment includes two ramp rails 140, identified as ramp rail 140A and ramp rail 140B. The launching system 100 is depicted in the launching position, with ramp rails 140A and 140B each attached to the flotation device 170 and each attached to a bracket 160 on the frame 20. In this embodiment, the frame 20 includes at least one holder bracket 360. More than one holder bracket 360 can be considered a plurality of holder brackets 360. The holder bracket 360 allows the ramp rail 140 to be completely attachable and detachable. When the launching system 100 is in a hauling position, the holder bracket 360 may be used to stabilize the ramp rails 140 while the launching system 100 is being hauled by a vehicle using the tow hitch assembly 70.

FIG. 4B depicts an enlarged view of the holder bracket 360. The holder bracket 360 includes a holder pin 362, a holder aperture 364, an inner surface 366, and an outer surface 368 opposite the inner surface 366. The ramp rail 140 may be placed adjacent to the inner surface 366 of the holder bracket 360 so that the holder bracket 360 partially surrounds the ramp rail 140. The holder pin 362 may be inserted into the holder aperture 364 and through other apertures placed in the ramp rail 140 to secure the ramp rail 140 to the frame 20 while the launching system 100 is being hauled.

FIG. 4C depicts an enlarged view of the connection between the bracket 160 and the ramp rail 140. The bracket 160 is rigidly attached to the frame 20, and the ramp rail 140 is positioned between the inner support 162 and the outer support 164 of the bracket 160. The pin 168 is depicted in the aperture 166 which penetrates through both the inner support 162 and the outer support 164 of the bracket 160. The pin 168 is depicted through another aperture in the ramp rail 140 in line with the aperture 166. The connection of the bracket 160 to the ramp rail 140 by use of the pin 168 and the aperture 166 allows rotation of the ramp rail 140 about the bracket 160. There may be other methods of connecting the ramp rail 140 and the bracket 160 that allow rotation of the ramp rail 140 about the bracket 160.

FIG. 4D depicts an enlarged view of the flotation device 170 connecting to ramp rails 140A and 140B. The ramp rail 140A is rigidly attached to the inner protrusion 172 and to the outer protrusion 174 opposite the inner protrusion 172. The ramp rail 140B is rigidly attached to another inner protrusion 172 and to another outer protrusion 174 opposite that other inner protrusion 172. The two inner protrusions 172 are connected by the inner chain 176. The inner chain 176 ensures that the ramp rails 140A and 140B do not separate too far apart. The two outer protrusions 174 connected to opposite rounded cylinder ends of the flotation device 170 by two outer chains 178. The combination of the outer chains 178 ensures that the ramp rails 140A and 140B do not get too close together, ensuring that even with movement of the water 30, a watercraft 10 can always be launched or recovered using the launching system 100. The combination of the inner chain 176 and the outer chains 178 ensures that the flotation device 170 stays beneath the ramp rails 140A and 140B during launching or recovering of the watercraft 10.

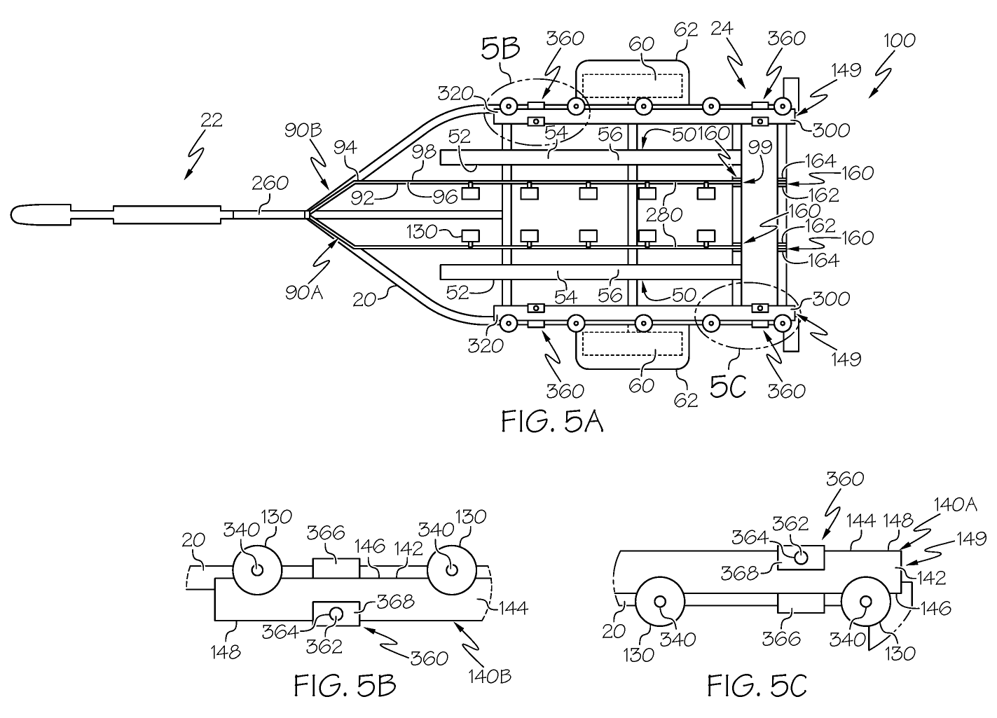

Referring now to FIGS. 5A-5C, FIG. 5A shows an embodiment of the launching system 100 from a top view and in a hauling position. The ramp rails 140A and 140B are each attached to two holder brackets 360, which are rigidly attached to the frame 20. When the launching system 100 is in a hauling position, the ramp rails 140A and 140B, as depicted in FIG. 5A, are positioned on their side. FIG. 5B depicts an enlarged view of the holder bracket 360 partially surrounding ramp rail 140B. The holder pin 362 is penetrated through the holder bracket 360 and through another aperture in ramp rail 140B. FIG. 5C depicts an enlarged view of the holder bracket 360 partially surrounding ramp rail 140A. In FIG. 5C, the holder pin 362 is penetrated through the holder bracket 360 and through another aperture in ramp rail 140A. The front engaging portion 300 and the rear engaging portion 320 of the ramp rails 140 switch positions when moving from the launching position to the hauling position, and as such, the front engaging portion 300 is always closest to the rear engaging portion 280 and the bracket 160.

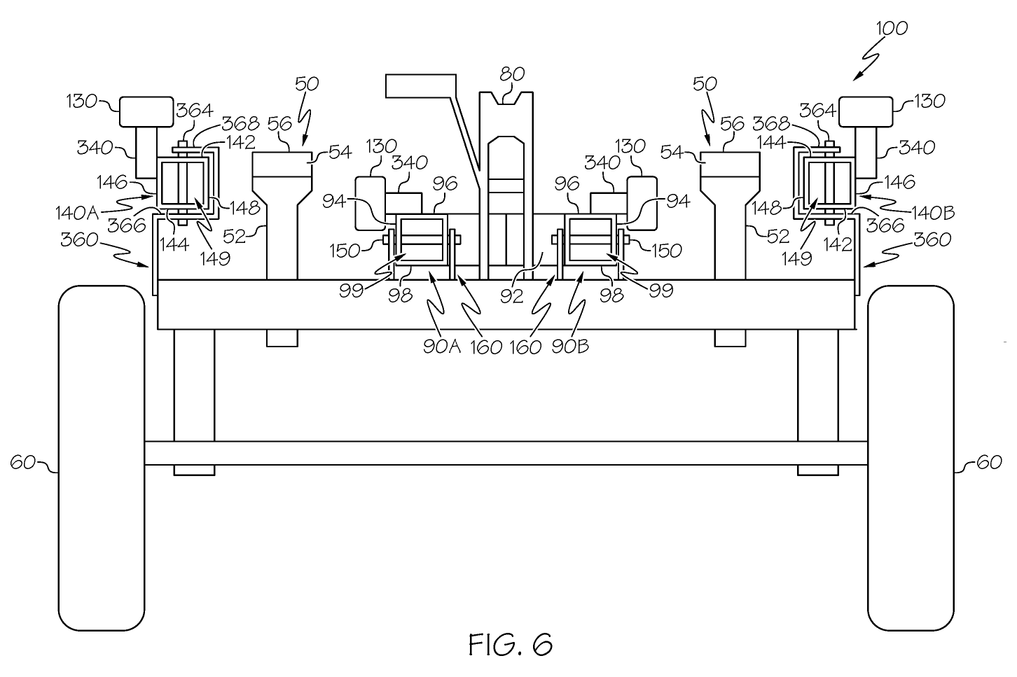

FIG. 6 depicts an embodiment of the launching system 100 in a hauling position and from a rear view. Clearly depicted are the connections between the support 52 and the pad 54 of the at least one bunk board 50. Also depicted in FIG. 6 are the rigid connections between the roller axis 340 and the top surface 96 of the lift rails 90 and the roller axis 340 and the top surface 146 of the ramp rails 140. Also clearly depicted in FIG. 6 are the apertures 99 and the apertures 149. The pin 168 extends through the bracket 160 and through the lift rail 90. The holder aperture 364 can be seen extending through the holder bracket 360 and the ramp rail 140.

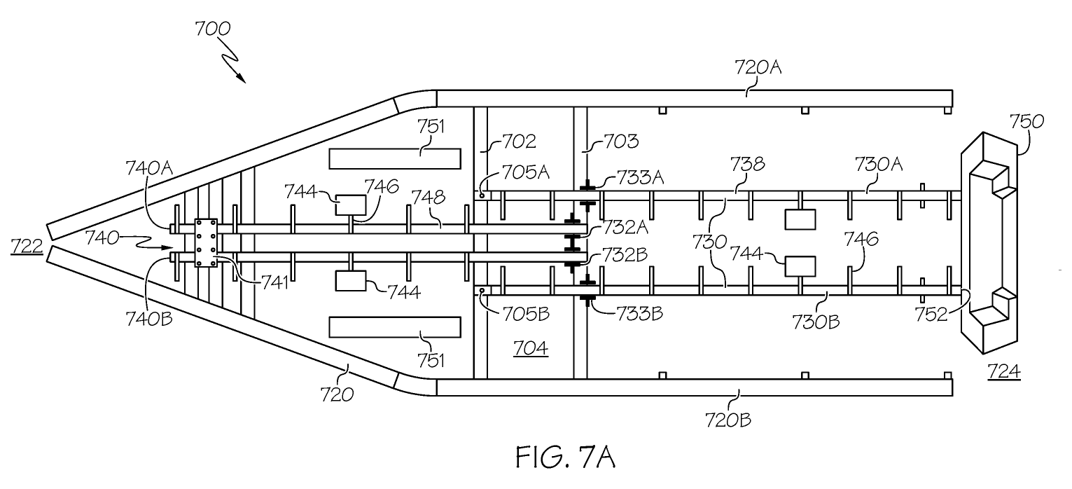

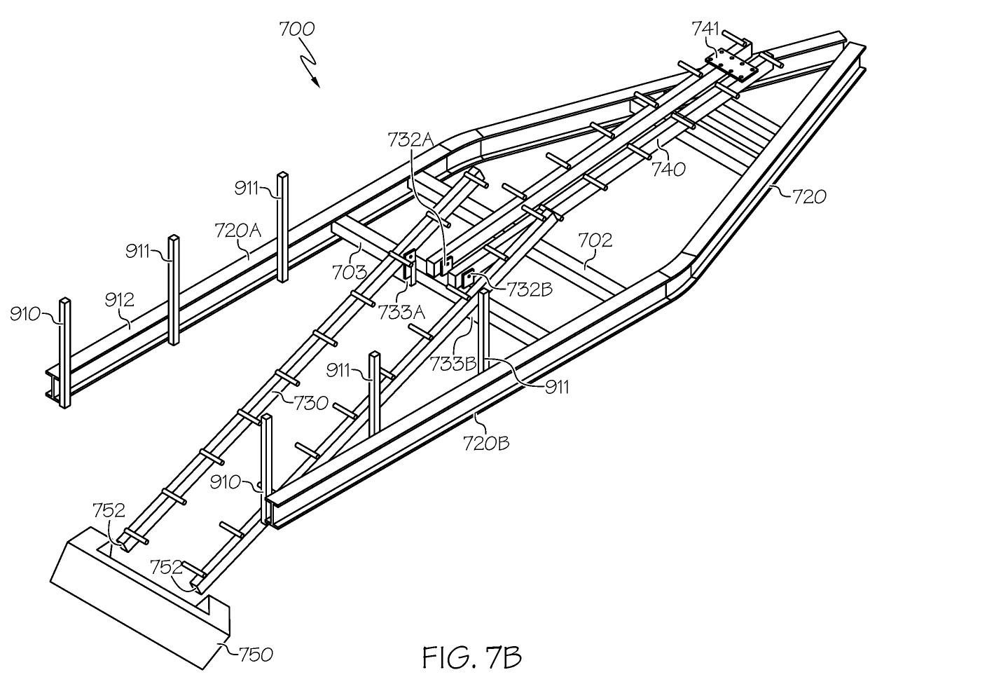

FIGS. 7A, 7B provide a plurality of views of a launching system 700 for towing and launching a personal watercraft, according to one or more embodiments shown and described herein. As described above, the launching system 700 may be movable between a hauling position and a launching position. FIG. 7A depicts the launching system 700 in a hauling position. Specifically, the launching system 700 includes a frame 720 and includes a vehicle side 722 and a water side 724. The frame 720 includes two outer frame members 720A and 720B that extend in a substantially parallel direction between the vehicle side 722 and the water side 724. The frame 720 additionally includes a first support rail 702 that extends in a substantially perpendicular direction to the outer frame members 720A and 720B and physically coupled the outer frame members 720A and 720B. A second support rail 703 is disposed substantially parallel to the first support rail 702 on the water side 724 of the frame 720 and also physically couples the outer frame members 720A and 720B. The first support rail 702 and the second support rail 703 define an intermediate section 704 located between the first support rail 702 and the second support rail 703 and within the frame 720. The frame 720 may include at least one bunk board 751 for use in the hauling position.

Also provided in FIG. 7A are a first lift rail 740A and a second lift rail 740B (collectively referred to as “lift rails 740”). Lift rails 740 are disposed substantially parallel to outer frame members 720A and 720B and are located within the frame 720 on the vehicle side 722. The first lift rail 740A is attached to the second support rail 703 via first lift rail bracket 732A. The second lift rail 740B is attached to the second support rail 703 via second lift rail bracket 732B. Lift rails 740 may be configured to rotate about first lift rail bracket 732A and second lift rail bracket 732B (collectively “lift rail brackets 732”). Lift rails 740 include at least one roller 744, comprising a roller axis 746 (which may be configured as an axle mechanism) attached to a top surface 748 of the lift rail 740, allowing the at least one roller 744 to rotate freely. The roller 744 may be constructed of rubber, polymer, biopolymer, and/or other material that allows a personal watercraft to move along the at least one roller 744 without damage.

Also provided in FIG. 7A are ramp rails 730A and 730B (collectively referred to as “ramp rails 730”). Ramp rail 730A is physically coupled to the frame 720 via a first ramp rail bracket 733A, which is located on the second support rail 703 between first lift rail bracket 732A and outer frame member 720A. Ramp rail 730B is physically coupled to the frame 720 via second ramp rail bracket 733B which is located on second support rail 703 between second lift rail bracket 732B and outer frame member 720B. Ramp rails 730 extend beyond second support rail 703 to first support rail 702. Accordingly, the ramp rails 730 are located outside the lift rails 740 and extend to overlap with the lift rails 740 in a middle section of the frame 720. The ramp rails 730 include at least one roller 744, comprising a roller axis 746 attached to a top surface 738 of the ramp rail 730, allowing the roller 744 to rotate freely.

As described above, embodiment of FIG. 7A depicts the launching system 700 in a hauling position. In the hauling position, lift rails 740 and ramp rails 730 are both substantially parallel to the ground (in the perspective of FIG. 7A, the lift rails 740 and ramp rails 730 are both coplanar with the page). Accordingly, a personal watercraft may rest on bunk boards 751 and rollers 744 of the lift rails 740 and ramp rails 730. When the launching system 700 is in a hauling position without a watercraft 913, first ramp rail locking pin 705A may join ramp rail 730A with first support rail 702, thereby locking ramp rail 730A into the hauling position. Second ramp rail locking pin 705B may join ramp rail 730B with first support rail 702. In embodiments, first ramp rail locking pin 705A and second ramp rail locking pin 705B (collectively, ramp rail locking pins 705) may be mounted on plates welded to ramp rails configured to align with brackets welded on first support rail 702.

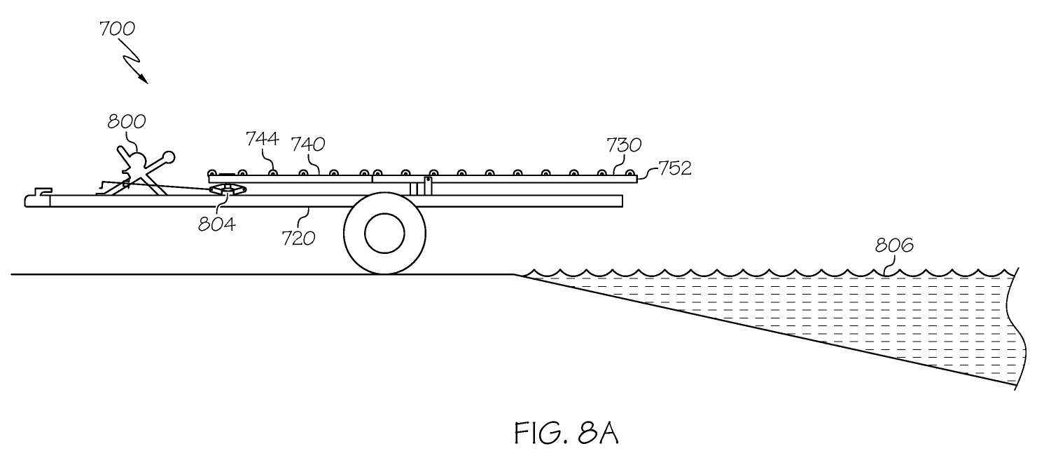

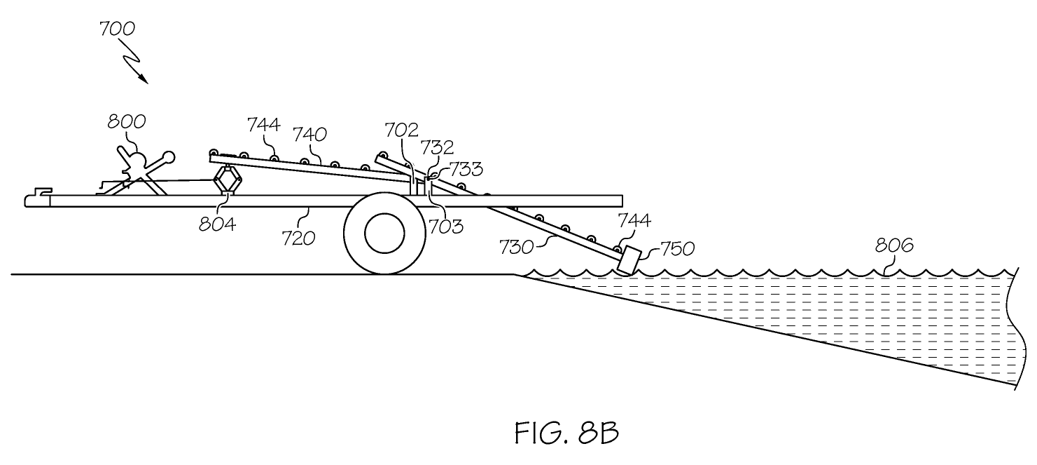

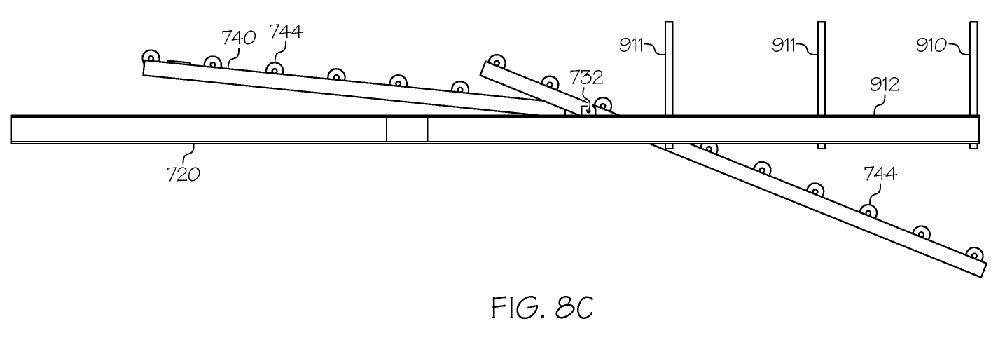

FIG. 7B provides a perspective view of the launching system 700 for towing and launching a personal watercraft in a launching position. While the depiction of the launching system 700 in FIG. 7A is an overhead view in the towing position, FIG. 7B depicts the launching system 700 in the launching position. During launch, a first actuator 804 (described in detail with reference to FIG. 8A) pushes the rear engagement portion 741 of the lift rails 740 upwards and away from the frame 720 (out of the page in FIG. 7A). Consequently, lift rails 740 form a ramp for deployment of a watercraft, such as a personal watercraft.

Similarly, ramp rails 730 rotate about at least one ramp rail bracket 733 downwards (into the page). Accordingly, the ramp rails 730 further create a slope for a watercraft, such as a personal watercraft to descend into the water. The ramp rails 730 comprise a distal edge 752 for mating with a floatation device 750. In addition, guide posts 911 and at least one rear guide post 910 is depicted, extending from a top surface 912 of the frame 720. Guide posts 911 and rear guide posts 910 may serve to guide a watercraft during launch.

While the launching system 700 is similar to the launching system 100 in FIG. 4A, to accommodate the unique lower geometry of a personal watercraft, while still accommodating other watercraft, ramp rails 730 extend into the frame 720, overlapping with a portion of lift rails 740. In addition, ramp rails 730 are positioned outside the lift rails 740 but within the frame 720, providing additional contact area for the watercraft during launching. The length of the lift rails 740 accommodate a personal watercraft with unique lower geometry by providing more surface area for contact with the watercraft. Personal watercrafts often have an elevated, sloping front surface that can slip or move on traditional launching systems. Accordingly, the configuration and length of the lift rails 740 and ramp rails 730 allows the launching system 700 to maintain contact with a personal watercraft during launching, hauling, and retrieval. This stabilizes and supports the personal watercraft during launch, as the ramp rails 730 contact the watercraft between the lift rails 740 and the outer frame members 720A and 720B, and both ramp rails 730 and lift rails 740 contact the watercraft as it traverses the launching system 700 during launch.

FIGS. 8A-8C depict various side views of the launching system 700 for towing and launching a watercraft, according to one or more embodiments provided herein. Specifically, FIG. 8A depicts the launching system 700 in a hauling position. First actuator 804, which may be a lift actuator, is rigidly connected to the frame 720. A user may operate a lift crank 800 (which may be manual and/or automatic) that is mechanically coupled to the first actuator 804. The lift crank 800 may move portions of the first actuator 804 so that the space between the top and the bottom of the first actuator 804 increases or decreases. Accordingly, the user may manually operate the lift crank 800 to deploy the first actuator 804. First actuator 804 is mechanically coupled to lift rails 740 and moves lift rails 740 based on the position of the first actuator 804. First actuator 804 is depicted in a hauling position and is not deployed. Accordingly, lift rails 740 are horizontal and parallel to both the ground and the frame 720. Similarly, ramp rails 730 are horizontal and parallel to both the ground and the frame 720.

FIG. 8B depicts a side view of the launching system 700 for towing and launching a watercraft, in a launching position according to embodiments provided herein. In particular, first actuator 804 is in an extended position, which is achieved by a user operating the lift crank 800. In some embodiments, the first actuator 804 may be operated by other mechanisms, such as hydraulic or electric motors, rather than a manual crank as depicted in FIG. 8B. Regardless, the first actuator 804 is coupled to lift rails 740 and, when in a launching position, moves rear engagement portion 741 of the lift rails 740 upwards, or away from the ground or water 806. Lift rails 740 rotate about lift rail bracket 732 and create an angle with respect to the horizon. Movement of the lift rails 740 creates a slope for the personal watercraft to move down the lift rails 740 and onto the ramp rails 730 via at least one roller 744. Ramp rails 730, due to the weight of the personal watercraft, may rotate about ramp rail brackets 733, causing the floatation device 750 to rotate below the frame 720 and into the water 806. The personal watercraft may exit the ramp rails 730 and enter at the surface of the water 806 in the direction of desired travel. Ramp rails 730 extend beyond second support rail 703 at least to overlay first support rail 702. Accordingly, the personal watercraft may contact both lift rails 740 and ramp rails 730 at the same time during launch. In embodiments, the frame 720 may extend beyond the ramp rails 730. In embodiments, the frame 720 is coterminal with the ramp rails 730.

The launching operation may be reversed when the watercraft is being recovered from the water. In particular, the system 700 may be in a launching position for recovery of a watercraft. The floatation device 750 keeps the end of the ramp rails 730 at the surface of the water 806 so that a user may place the personal watercraft at the ends of the ramp rails 730. As the user pushes or drives the personal watercraft up the ramp rails 730, the ramp rails 730 rotate about ramp rail brackets 733 in an upward direction, moving from below the frame 720 into a horizontal position parallel to the frame 720. In addition, the first actuator 804 may lower (via operation of the lift crank 800) from an extended position, thereby lowering the rear engagement portion 741 of the lift rails 740. The lift rails 740 move until substantially parallel to the ramp rails 730. This facilitates the recovery of the personal watercraft and returns the personal watercraft to its original hauling position on the system 700.

FIG. 8C depicts another view of the launching system 700 for towing and launching a personal watercraft in a launching position according to embodiments provided herein. Guide posts 911 and rear guide posts 910 may extend from a top surface 912 of the frame 720. Guide posts 911 and rear guide posts 910 serve to further direct the watercraft during launching and recovery. In embodiments, the rear guide posts 910 may include trailer lights. In embodiments, the guide posts 910 and/or rear guide posts 911 may be constructed of aluminum or other rigid material, either bolted to welded to the frame, covered with a PVC (or other polymer) tube to protect watercraft from abrasion during loading and unloading if watercraft comes into contact with the guide posts 910 and/or the rear guide posts 911. In embodiments, guide posts 911 and rear guide posts 910 may be formed continuously with the frame 720. In embodiments, the base of guide posts 911 and rear guide posts 910 may be formed continuously with the frame 720 and the top of the guide posts 911 and rear guide posts 910 may be constructed of PVC or another polymer. Also depicted in FIG. 8C is the ramp rail 730 in its extended position. Specifically, the ramp rail 730 extends to overlap with lift rail 740 in the launching position. Accordingly, the ramp rails 730 extend beyond the lift rail bracket 732 and rise above the frame 720.

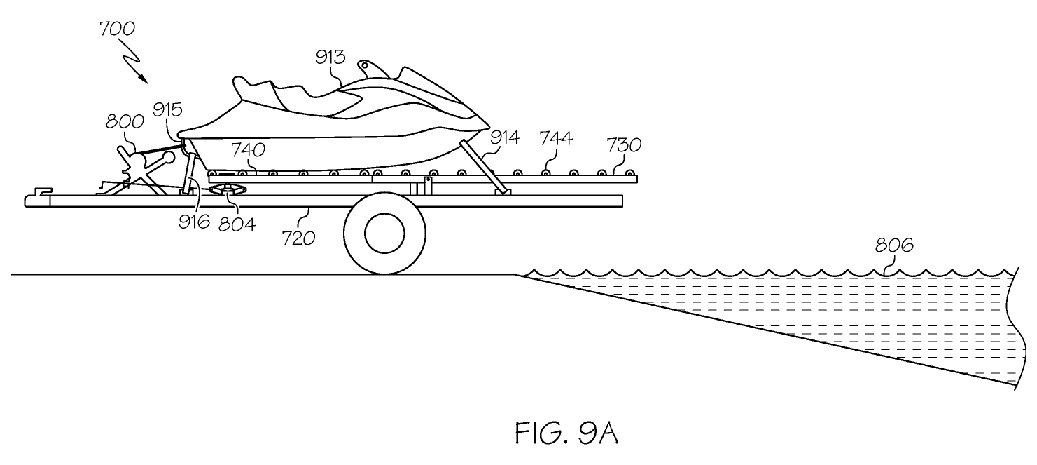

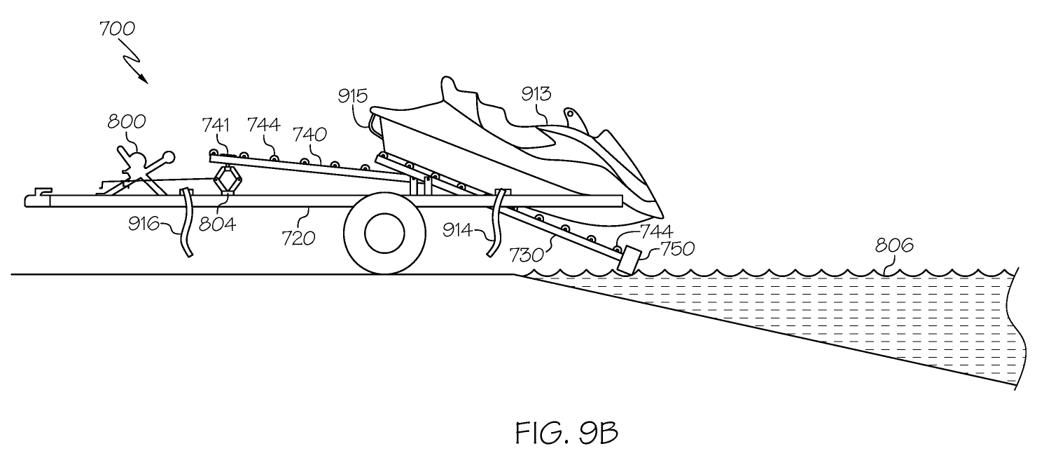

FIGS. 9A, 9B are various side views of a launching system 700 for towing and launching a personal watercraft 913, according to embodiments provided herein. In particular, FIG. 9A depicts an embodiment of the launching system 700 in side view with a personal watercraft 913 resting on the launching system 700. The personal watercraft 913 rests atop bunk boards 751 and rollers 744 on lift rails 740 and ramp rails 730. In embodiments, one or more quick release straps 914 may be attached to the frame 720 and configured to connect with a front of the watercraft 913. The quick release straps 914 may further secure the personal watercraft 913 to the launching system 700. In embodiments, lift crank 800 may be attached to tow bar 915, a horizontal bar that may be attached to personal watercraft 913. Tow bar 915 may provide an attachment to secure the rear of the watercraft 913 to the frame 700 during hauling. Optionally, one or more rear quick release straps 916 may be rigidly attached to the vehicle side 722 of the frame 720, and the one or more rear quick release straps 916 may be configured to attach to the tow bar 915. Accordingly, the one or more rear quick release straps 916 may further stabilize the watercraft 913 during hauling but also serve to facilitate fast and efficient launch of the personal watercraft 913.

FIG. 9B depicts an embodiment of the launching system 700 in side view in a launching position. Personal watercraft 913 is depicted during launch in the direction of desired travel. Accordingly, a rear end of the watercraft is lifted upwards, and the weight of the personal watercraft 913 causes the personal watercraft 913 to slide down lift rails 740. As the personal watercraft 913 moves downwards, the personal watercraft 913 transitions to the ramp rails 730, which extend to contact the personal watercraft 913 while on lift rails 740. The floatation device 750 maintains a space between the ramp rails 730 and the ground level under water, so that the watercraft bottom remains higher and does not drag on the ground when being launched or loaded. Accordingly, after launch, the personal watercraft 913 is at the surface of the water and facing the desired direction of travel.

As also illustrated in FIG. 9B, the first actuator 804, which is attached to the frame 720 and coupled to the rear engagement portion 741 of the lift rails 740, is extended further than as depicted in FIG. 9A, allowing the personal watercraft 913 to roll along the rollers 744 of the lift rails 740 onto the rollers 744 of the ramp rail 730. During launch, a user may disengage the one or more rear quick release straps 916 from the tow bar 915, thereby allowing the personal watercraft 913 to move down lift rails 740. Accordingly, the tow bar 915 remains attached to the personal watercraft 913 during launch. The first actuator 804 may be configured to extend even further to launch the personal watercraft 913 into the water 806 or may be extended less and still allow for the personal watercraft 913 to be launched, depending on the specific requirements of the launch. The extensive coverage of the lift rail 740 supports the unique geometry of a personal watercraft 913, offering enhanced contact area for the sloping front of a personal watercraft 913 and maintaining contact and control as the watercraft is lowered into the water. From the above, it is to be appreciated that defined herein is a system and method for launching and recovering a watercraft, utilizing an adjustable frame, lift rails 740, ramp rails 730, and associated hardware to facilitate controlled transfer of a watercraft between a towing vehicle and a body of water.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

1. A launching system for towing and launching a watercraft, comprising:
a frame including a vehicle side and a water side, wherein the frame includes at first lift rail bracket and a second lift rail bracket, and a first ramp rail bracket and a second ramp rail bracket;
a first lift rail coupled to the vehicle side of the first lift rail bracket such that the first lift rail rotates about the first lift rail bracket, wherein the first lift rail is disposed along a launch direction;
a second lift rail coupled to the vehicle side of the first lift rail bracket such that the second lift rail rotates about the second lift rail bracket, wherein the second lift rail is disposed along the launch direction, wherein the first lift rail and the second lift rail rotate about the first lift rail bracket and second lift rail bracket to create a lift angle with respect to the frame, wherein the watercraft is disposed on the first lift rail and the second lift rail during towing;
a first ramp rail coupled to the water side of the first ramp rail bracket such that the first ramp rail rotates about the first ramp rail bracket, wherein the first ramp rail is positioned in between the first lift rail and the frame and is disposed along the launch direction during launch, and wherein the first ramp rail extends past the first ramp rail bracket so that a portion of the first ramp rail is parallel to and collinear with the first lift rail;
a second ramp rail coupled to the water side of the second ramp rail bracket such that the second ramp rail rotates about the second ramp rail bracket, wherein the second ramp rail substantially aligns with the second lift rail and is disposed along the launch direction during launch, wherein the first ramp rail and the second ramp rail rotate about the first ramp rail bracket and the second ramp rail bracket to create a ramp angle with respect to the frame; and
a lift actuator located toward the vehicle side of the frame configured to change a position of the first lift rail and the second lift rail with regard to the frame, thus changing the lift angle such that the watercraft slides from the first lift rail and the second lift rail to the first ramp rail and the second ramp rail during launch,
wherein when the watercraft is disposed on the first ramp rail and the second ramp rail during launch, a weight of the watercraft causes the ramp angle to increase to be greater than the lift angle as the watercraft enters a body of water.

2. The launching system of claim 1, wherein the second ramp rail extends past the second lift rail bracket so that a portion of the second ramp rail is parallel to and collinear with the second lift rail.

3. The launching system of claim 1, further comprising:
a first plurality of rollers disposed on the first ramp rail and the second ramp rail, wherein the first plurality of rollers is engaged to a respective first plurality of roller axes that are disposed on the first ramp rail and the second ramp rail perpendicular to the first ramp rail and the second ramp rail; and
a second plurality of rollers disposed on the first lift rail and the second lift rail, wherein the second plurality of rollers is disposed on a respective second plurality of roller axes that are disposed on the first lift rail and the second lift rail perpendicular to the first lift rail and the second lift rail.

4. The launching system of claim 1, wherein the first ramp rail and the second ramp rail are detachable from the first ramp rail bracket and the second ramp rail bracket for storage during towing, and wherein the launching system further comprises a plurality of holder brackets attached to the frame, configured to couple the first ramp rail and the second ramp rail during towing.

5. The launching system of claim 1, wherein
a first support rail extends in a substantially perpendicular direction to the frame;
a second support rail extends in a substantially parallel direction to the first support rail on the water side of the frame, wherein the first support rail and the second support rail define an intermediate section; and
wherein the first lift rail bracket and the second lift rail bracket are physically coupled to the second support rail, and the first ramp rail bracket and the second ramp rail bracket are physically coupled to the second support rail.

6. The launching system of claim 1, further comprising a flotation device that is secured toward the water side of the first ramp rail and the second ramp rail during launch and between the first ramp rail and the second ramp rail during launch.

7. The launching system of claim 1, further comprising a winch actuator that is secured toward the vehicle side of the frame, configured to control speed of the watercraft during launch and assist loading of the watercraft before towing.

8. The launching system of claim 7, further comprising a winch cable to connect the winch actuator to the watercraft.

9. A launching system for towing and launching a watercraft, comprising:
a frame including a vehicle side and a water side;
a first support rail that extends in a substantially perpendicular direction the frame;
a second support rail extends substantially parallel to the first support rail on the water side of the frame, wherein the first support rail and the second support rail define an intermediate section, and wherein the second support rail includes a first lift rail bracket and second lift rail bracket, and a first ramp rail bracket and a second ramp rail bracket and wherein the first ramp rail bracket is disposed between the first lift rail bracket and the frame, and wherein the second ramp rail bracket is disposed between the second lift rail bracket and the frame;
a first lift rail coupled to the vehicle side of the first lift rail bracket such that the first lift rail rotates about the first lift rail bracket, wherein the first lift rail is disposed along a launch direction;
a second lift rail coupled to the vehicle side of the second lift rail bracket such that the second lift rail rotates about the second lift rail bracket, wherein the second lift rail is disposed along the launch direction, wherein the first lift rail and the second lift rail rotate about the first lift rail bracket and the second lift rail bracket to create a lift angle with respect to the frame, wherein the watercraft is disposed on the first lift rail and the second lift rail during towing;
a first ramp rail coupled to the water side of the first ramp rail bracket such that the first ramp rail rotates about the first ramp rail bracket, wherein the first ramp rail substantially aligns with the first lift rail and is disposed along the launch direction during launch;
a second ramp rail coupled to the water side of the second ramp rail bracket such that the second ramp rail rotates about the second ramp rail bracket, wherein the second ramp rail lines up with the second lift rail and is disposed along the launch direction during launch, wherein the first ramp rail and the second ramp rail rotate about the first ramp rail bracket and the second ramp rail bracket to create a ramp angle with respect to the frame;
a lift actuator located toward the vehicle side of the frame, configured to change a position of the first lift rail and the second lift rail with regard to the frame, thus changing the lift angle such that the watercraft slides from the first lift rail and the second lift rail to the first ramp rail and the second ramp rail during launch; and
a flotation device that is secured toward the water side of the first ramp rail and the second ramp rail during launch and between the first ramp rail and the second ramp rail during launch,
wherein when the watercraft is disposed on the first ramp rail and the second ramp rail during launch, a weight of the watercraft causes the ramp angle to increase to be greater than the lift angle as the watercraft enters a body of water.

10. The launching system of claim 9, further comprising
a first plurality of rollers disposed on the first ramp rail and the second ramp rail, wherein the first plurality of rollers is engaged to respective first roller axes that are disposed on the first ramp rail and the second ramp rail perpendicular to the first ramp rail and the second ramp rail; and
a second plurality of rollers disposed on the first lift rail and the second lift rail, wherein the second plurality of rollers is disposed on respective second roller axes that are disposed on the first lift rail and the second lift rail perpendicular to the first lift rail and the second lift rail.

11. The launching system of claim 9, wherein the first ramp rail extends past the first ramp rail bracket and the second ramp rail extends past the second ramp rail bracket so that a portion of the first ramp rail is parallel to and collinear with the first lift rail and a portion of the second ramp rail is parallel to and collinear with the second lift rail.

12. The launching system of claim 9, wherein the first ramp rail and the second ramp rail are detachable from the first ramp rail bracket and the second ramp rail bracket for storage during towing.

13. The launching system of claim 12, further comprising a plurality of holder brackets attached to the frame, configured to couple to the first ramp rail and the second ramp rail during towing.

14. The launching system of claim 9, further comprising:
a winch actuator that is secured toward the vehicle side of the frame, configured to control speed of the watercraft during launch and assist loading of the watercraft before towing; and
a winch cable to connect the winch actuator to the watercraft.

15. The launching system of claim 9, further comprising:
at least one guide post extending from a top surface of the frame; and
at least one rear guide post extending from the top surface of the frame located on the water side of the at least one guide post.

16. A launching system for towing and launching a watercraft, comprising:
a frame including a vehicle side and a water side, wherein the frame includes at least one lift rail bracket and at least one ramp rail bracket;
at least one lift rail coupled to the vehicle side of the at least one lift rail bracket such that the at least one lift rail rotates about the at least one lift rail bracket, wherein the at least one lift rail is disposed along a launch direction;
wherein the at least one lift rail rotates about the at least one lift rail bracket to create a lift angle with respect to the frame, wherein the watercraft is disposed on the at least one lift rail during towing;
at least one ramp rail coupled to the water side of the at least one ramp rail bracket such that the at least one ramp rail rotates about the at least one ramp rail bracket, wherein the at least one ramp rail substantially aligns with the at least one lift rail and is disposed along the launch direction during launch, and wherein the at least one ramp rail rotates about the at least one ramp rail bracket to create a ramp angle with respect to the frame;
a first actuator located toward the vehicle side of the frame, configured to change a position of the at least one lift rail with regard to the frame, thus changing the lift angle such that the watercraft slides from the at least one lift rail to the at least one ramp rail during launch; and
a second actuator that is secured toward the vehicle side of the frame, configured to control speed of the watercraft during launch and assist loading of the watercraft before towing.

17. The launching system of claim 16, further comprising a first plurality of rollers disposed on the at least one ramp rail, wherein the first plurality of rollers is engaged to respective first roller axes that are disposed on the at least one ramp rail perpendicular to the at least one ramp rail.

18. The launching system of claim 16, further comprising a second plurality of rollers disposed on the at least one lift rail, wherein the second plurality of rollers is disposed on respective second roller axes that are disposed on the at least one lift rail perpendicular to the at least one lift rail.

19. The launching system of claim 16, wherein the at least one ramp rail is detachable from the at least one ramp rail bracket for storage during towing.

20. The launching system of claim 16, wherein the at least one ramp rail comprises a first ramp rail and a second ramp rail, and a flotation device is secured toward the water side of the first ramp rail and the second ramp rail during launch and between the first ramp rail and the second ramp rail during launch.
